(19) United States
(12) Patent Application Publication
(10) Pub. No.: US 2026/0346097 A1
(43) Pub. Date: Nov. 5, 2026

(54) BORON & CARBON FIBER RACKET & PADDLES

(71) Applicant: Volair LLC, Austin, TX (US)

(72) Inventors: Ryan Cohen, Austin, TX (US); Ze-Ching Ong, Austin, TX (US)

(21) Appl. No.: 19/663,188

(22) Filed: Apr. 29, 2026

Related U.S. Application Data
(60) Provisional application No. 63/798,524, filed on May 1, 2025.

(51) Int. Cl. A63B 49/10; A63B 59/42; A63B 60/00; A63B 60/54; B32B 5/02

(52) U.S. Cl. CPC A63B 49/10; A63B 60/002; A63B 60/54; B32B 5/02; A63B 59/42; A63B 2209/02; A63B 2209/10; B32B 2260/023; B32B 2260/046; B32B 2262/10; B32B 2262/106; B32B 2262/14; B32B 2307/56

(57) ABSTRACT

A sports racket includes a handle, a shaft or connection point coupled to the handle, a frame coupled to the shaft or connection point, and a ball-striking surface, wherein at least one component of the sports racket comprises a hybrid boron fiber carbon fiber prepreg including boron fibers and carbon fibers in a resin matrix. In various embodiments, the hybrid boron fiber carbon fiber prepreg is disposed in one or more selected regions of the sports racket, including a neck area between the handle and a paddle or racket face, a perimeter of the frame, a face sheet or surface laminate, or a removable covering coupled to the surface. Strategic placement of the hybrid boron fiber carbon fiber prepreg can reduce noise produced during contact between the sports racket and a ball, modify a noise signature of the resulting impact sound, increase torsional stiffness and control, and alter performance characteristics including power, pop, spin, and hand feel. The sports racket may be a paddle or a stringed racket, including embodiments in which the frame includes a throat, yoke, or shaft supporting a string bed. Methods are also disclosed for manufacturing a sports racket by forming at least one racket component from the hybrid boron fiber carbon fiber prepreg and laminating the prepreg in one or more selected regions of the sports racket.

### BACKGROUND

### Technical Field

The present disclosure relates to sporting goods. More particularly, and not by way of limitation, the present disclosure relates to sporting rackets made with a hybrid boron fiber and carbon fiber composite material and the associated processes.

### Problems Solved

Pickleball and other racket and paddle sports have experienced rapid growth in participation, which has led to the construction of new outdoor courts in many residential communities in the United States and abroad. As the number of players and available courts has increased, neighbors living near outdoor pickleball and similar courts have raised concerns regarding the distinct, repetitive impact noise generated when a hard ball strikes a rigid paddle or racket. In many instances, this impact noise is described as loud, intrusive, and difficult to ignore in nearby homes and yards. In addition to community noise complaints, some players and nearby audiences have reported ear ringing or tinnitus on social-media forums and in advocacy-oriented articles. Players can also be concerned about the noise because commentators citing public-health guidance on prolonged exposure above about 85 dBA have speculated that the repetitive “pop” of pickleball impacts—measured in some instances around 85 dBA at distances on the order of 100 feet—may pose a potential hearing-health concern if exposure is sufficiently frequent and prolonged, although published clinical studies to date have not demonstrated actual noise-induced hearing loss in pickleball players.

Various reports describe disputes between players and residents, public hearings, and actions by municipalities and private communities directed to mitigating or restricting play in view of noise impacts from racket-ball contact. In response, some communities have installed sound-attenuating barriers, relocated or limited courts, restricted hours of play, or moved play indoors. While such measures may provide some relief, they can be costly, may not fully address the noise for all affected residents, and often do not treat the sound at its source, namely the impact between the racket and the ball.

In the field of sports equipment, numerous racket and paddle constructions employ composite materials such as carbon fiber, fiberglass, and other fiber-reinforced resins to provide desired strength, stiffness, weight, and feel characteristics. Some known designs include multi-layer laminates, honeycomb cores, foam cores, and vibration-damping inserts intended to improve feel, reduce shock transmitted to the player, or enhance durability. External to the racket itself, others have proposed acoustic fencing, sound-absorbing panels positioned around the court, and court siting strategies to reduce propagation of impact-generated noise into surrounding neighborhoods. However, such approaches generally focus on player comfort or external noise-abatement structures, and do not teach or suggest forming selected racket components from hybrid boron fiber-carbon fiber prepregs and strategically laminating such materials in specific regions of the racket (e.g., neck area, perimeter, face sheet, or surface) to directly reduce airborne noise produced at the moment of impact between the racket and the ball.

Moreover, existing rackets and paddles often represent a compromise between power, control, torsional stiffness, durability, and feel, particularly on off-center impacts. Many conventional constructions rely on homogeneous carbon fiber or fiberglass laminates, edge guards, and core materials that provide adequate strength and weight but may not deliver localized reinforcement in critical regions such as the neck between the handle and the head or the perimeter of the frame. As a result, torsional stiffness about the longitudinal axis can be limited, leading to twisting and loss of directional control on off-center hits, and hand feel can vary from impact to impact.

In addition, known constructions typically do not provide integrated, removable coverings that can be coupled to the racket surface and that themselves incorporate performance materials, such as hybrid boron fiber-carbon fiber prepregs, to selectively modify racket characteristics including strike point, power, pop, spin, and audible frequency, or to adapt a single racket body for different playing environments.

Accordingly, there remains a need for sports rackets and paddles that intrinsically reduce impact generated noise, thereby helping to address community and residential noise concerns without relying solely on external barriers, court relocation, or usage restrictions. There is a further need for material systems and constructions for racket components, including the handle, shaft or connection point, frame, and surface region, that can increase torsional stiffness and axial stiffness, improve control and consistency of hand feel, and provide tunable performance characteristics such as power, pop, strike point, and spin, while maintaining desirable weight and durability. In some examples, it is desirable not only to lower the overall noise level (for example, peak sound pressure level in decibels) but also to alter the noise signature of the impact, where “noise signature” refers to the frequency content and temporal character of the sound that determine how sharp, high pitched, or intrusive the impact “pop” is perceived by nearby listeners. The present disclosure addresses these needs by providing sports rackets, paddles, and associated methods in which at least one racket component is formed from a hybrid boron fiber carbon fiber prepreg and laminated in one or more layers in selected racket regions (for example, in the neck area between the handle and the paddle or racket face, around the perimeter, in a face sheet surface or laminate, or in a removable covering) to reduce noise caused by contact between the sports racket and a ball, to modify the impact noise signature, increase torsional stiffness and control, and modify impact and spin behavior relative to comparable rackets lacking the hybrid prepreg in those regions.

### Description of Related Art

Pickleball and padel are among some of the fastest growing racket sports. The material selection, process, utilization, and design may be chosen such that a sports racket delivers improved performance, durability, and comfort for the player, audience, and community. Therefore, the use of advanced materials in racket sport goods applications has the potential to generate a competitive advantage for the user and their audience or community.

U.S. Patent Application Publication No. 2022/0409969 to Ducharme et al. describes hockey stick blades and shafts formed partially or wholly from boron-enhanced fiber materials, including fiber tapes in which boron fibers are embedded within a resin matrix and, in some embodiments, combined with carbon fibers to reduce weight and improve strength and stiffness of the blade and shaft structures. The boron-enhanced materials may be applied as layers, tapes, or patches in selected regions of the blade or shaft to tune mechanical properties such as compressive strength and linear density, and the publication notes that similar boron-enhanced constructions could be used in other sporting implements such as lacrosse sticks, bats, and racquets.

U.S. Pub. Pat. App. No. 2023/0047371 (published Feb. 16, 2023) teaches that pickleball paddles originally were made of wood but “these days, the pickleball paddle may be made from glass fiber, composite materials and graphite fiber. [0003]. Glass fiber is more commonly known as “fiberglass.” It would be advantageous to have an apparatus, system, and method of sporting good rackets made with a hybrid boron fiber and carbon fiber composite material that furthers sports racket technology and provides performance benefits for the user and noise relief to pickleball audiences and court-side communities. The present disclosure provides such an apparatus, system, and method. Applicant does not understand this reference to disclose configuring a pickleball paddle to modify the noise signature of a ball-to-paddle impact (for example, by tailoring the frequency content or character of the impact sound), as distinguished from merely selecting among conventional composite face materials.

Moreover, there remains a need for sports rackets and paddles that intrinsically reduce impact-generated noise, thereby helping to address community and residential noise concerns without relying solely on external barriers, court relocation, or usage restrictions. In particular, there is a need for material systems and constructions for racket components, including the handle, shaft or connection point, frame, and surface region, that can attenuate and modify the sound produced when the racket contacts a ball while maintaining desirable performance characteristics such as stiffness, control, power, and durability. US 2021/0252356 A1 in para. [0161] addressed the need for “reduced noise” via filling the cells of a cellular inner-layer of a pickleball paddle with “foam material,” thereby damping impact-generated vibration within the paddle core. US 2025/0170467 A1 discloses alternative pickleball paddle constructions that reduce or alter impact noise primarily by modifying the paddle's face and core stack-up, for example by introducing flexible foam and porous intermediate layers, segmented or “fractionalized” stiff layers, and tuned multi-layer face constructions configured to increase ball-paddle contact time, reduce peak impact force, and fractionalize the acoustic radiation area while preserving playability and coefficient of restitution. By contrast, the present disclosure addresses these needs by providing sports rackets, paddles, and associated methods in which at least one racket component is formed from a hybrid boron fiber-carbon fiber prepreg and laminated in one or more layers in selected racket regions (for example, in the neck area between the handle and the paddle or racket face, around the perimeter, or in a face sheet surface or laminate) to reduce the noise caused by contact between the sports racket and a ball.

### BRIEF SUMMARY

The present disclosure relates to sporting goods comprising a handle; a shaft or connection point coupled to the handle; a frame coupled to the shaft or connection point, the frame comprising at least one of a racket split, yoke, throat, shoulders, side edges, and a top edge; and a ball-striking surface surrounded by the frame, wherein at least one component of the sports racket comprises a fiber-reinforced composite material. In various embodiments, at least one component of the sports racket comprises one or more layers of a hybrid boron fiber carbon fiber prepreg including boron fibers and carbon fibers in a surrounding resin matrix, and the hybrid boron fiber carbon fiber prepreg may be disposed in selected regions of the sports racket including a neck area between the handle and a paddle or racket face, a perimeter of the frame, a face sheet or surface laminate, or a removable covering coupled to the surface. The sports racket may be a paddle or a stringed racket, including embodiments in which the frame includes a throat and yoke supporting a string bed. In certain embodiments, strategic placement of the hybrid boron fiber carbon fiber prepreg in one or more selected regions can reduce noise produced during contact between the sports racket and a ball, modify a noise signature of the resulting impact sound, increase torsional stiffness and control, and provide a more consistent hand feel during off-center impacts. In further embodiments, the present disclosure provides methods of manufacturing and configuring a sports racket by forming at least one selected component from the hybrid boron fiber carbon fiber prepreg and laminating the prepreg in one or more selected regions of the sports racket to reduce impact-generated noise and increase torsional stiffness relative to a comparison sports racket lacking the hybrid boron fiber carbon fiber prepreg in those regions.

Other aspects, embodiments and features of the present disclosure will become apparent from the following detailed description when considered in conjunction with the accompanying figures. In the figures, each identical, or substantially similar component that is illustrated in various figures is represented by a single numeral or notation. For purposes of clarity, not every component is labeled in every figure. Nor is every component of the disclosure shown where illustration is not necessary to allow those of ordinary skill in the art to understand the disclosure.

In certain embodiments, the present disclosure further provides methods directed to performance characteristics of the sports racket, including a method of reducing noise produced during contact between a sports racket and a ball and a method of increasing torsional stiffness and control of a sports racket. In these methods, at least one component of the sports racket—such as a neck area between the handle and a paddle or racket face, a perimeter of a paddle or racket frame, a face sheet surface or laminate, or a surface configured to strike the ball—is formed from and laminated with one or more layers of a hybrid boron fiber-carbon fiber prepreg comprising boron fibers and carbon fibers in a resin matrix. By strategically placing the hybrid boron fiber-carbon fiber prepreg in these regions, the sports racket can be configured such that peak sound pressure levels associated with ball impact are reduced relative to a comparison racket lacking the hybrid prepreg in those regions, and such that torsional stiffness about a longitudinal axis is increased to provide improved control and a more consistent hand feel during off-center impacts.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a front view of a sports racket;

FIG. 2 is a bottom view of the sports racket;

FIG. 3 is a top view of the sports racket;

FIG. 4 is a side view of the sports racket, which is a mirror image of the opposite side; and

FIG. 5 is side perspective view of the sports racket;

FIG. 6 is a front view of a Sports racket with a covering;

FIG. 7 is a front view of a sports racket with a covering; and

FIG. 8 is a front view of a sports racket with a covering.

FIG. 9A is a front view of a small badminton or tennis racket.

FIG. 9B is a side perspective view of a small badminton or tennis racket.

FIG. 9C is a side view of a small badminton or tennis racket.

FIG. 10A is a front view of a tennis racket.

FIG. 10B is a lower perspective side view of a tennis racket.

### DETAILED DESCRIPTION

Embodiments of the disclosure will now be described.

Sports rackets (may also be referenced as a paddle, or sports paddle) may include a handle, shaft, frame, head, and/or face surface that may be at least partially constructed with fiber-reinforced composite material. These composites are typically composed of plies or layers of high modulus and high strength material fibers that are partially or fully enclosed by a matrix material. The fibers in each ply may be chopped, woven, or run unidirectionally. The individual plies may then be arranged and laminated together to form a composite structure that may be any component of the sports racket.

As noted above sport rackets can include various components, including but not limited to, a handle, shaft, frame, head, and/or face surfaces, connection points, and/or other structural or ornamental features. A handle of a sport racket is the portion of the racket and/or paddle that allows a user to grip the sports racket during use. Many handles for sports paddles are elongated cylindrical designs with a cross section (perpendicular to the elongation) that is round, oval, and/or polygonal. In some examples, the handle is design to maximize ergonomic comfort and/or control using cushioned or textured grips or wraps that can increase comfort and/or control. Similarly, handles may also be customized to allow for a minimization of shock and vibration using various materials or material layers, additionally, through layering there can be changes to the weight of the sport racket allowing for changes in movement and/or control. While some examples may allow for the removal of the handle from the sports racket, for various reasons (including weight), this is not typically done, similarly, there may also be electronics placed within the sport racket that allows for a user to know specific metrics of play.

In some designs, the handle may surround a shaft (increased thickness in a handle section), or may be coupled to a shaft through various coupling or connection means, while in other designs the shaft and handle are formed of the same material and the shaft acts as an extension of the handle without a grip and/or wrap surrounding it. Regardless, the shaft (or in some cases a connection point) can allow for the handle to be engaged with a head and/or frame of a sports racket. For example, in pickleball paddle versions of a sports racket, the shaft is often part of the handle and forms a connection point with the main body or face surface of the sports racket. However, for a tennis racket version of the sports racket, there can be a section that includes a narrowed version of a shaft extending beyond the handle in a manner to connect to the frame, and/or head surface. The shaft may allow for a tapered design in its width and/or thickness, as well as being engineered to have specific flex zones or points, reinforced areas, and/or layers that allow for specific types of game play action such as spin, speed, and/or control. Similarly, the shaft may be designed for desired weight characteristics that allow for specific balance points for different users and/or use cases. This may be achieved through the cross-section design of the shaft, and/or the material makeup or layering of the shaft during manufacturing.

The shaft can allow for a coupling and/or connection to the frame and/or main body of a sports racket, either directly or through a connection point. The frame or main body is often seen as the structural body of the sports racket. It can allow for a head and/or face surface to be attached and/or engaged with the other components of the sports racket. The frame and/or main body can also provide a structural body that can surround and/or support the face, head, and/or string bed of a sport racket, while also providing shape, rigidity, and/or structural integrity. In a tennis racket version of the sports racket, the frame may include a yoke, throat, and/or outer rim, and form a closed area (often a loop of various rounded shapes) that allows for the head and/or strings to be tensioned. In a pickleball paddle version of the sports racket, the frame will often include a solid or honeycomb structured core, that can be a form of unibody design or may allow for various channels and/or supports throughout and/or along the perimeter. These frames are often designed for specific weight, balance, and action types (inertia, impact, resilience, spin, etc.) through a combination of materials, shapes, layers, that can often include but are not limited fiberglass, carbon fiber, graphite, and/or reinforced polymers. Edge guards may also be incorporated to prevent damage to the frame of a sports racket if the ground or other object is hit. Similarly, the frame geometry may be engineered and/or manufactured to allow for various effects related to aerodynamics, the sweet spot, stiffness, precision, speed, and/or consistency. The frame may also allow for the incorporation of electronics or sensors for advance engineering, analytics, and/or development of sports rackets, and/or players. As noted, the frame can support a head and/or face surface, that serves as the primary contract area for a ball or other object that is struct as part of the sport.

Boron fibers can be incorporated into carbon fiber prepreg to tailor the material characteristics and performance of the final hybrid boron fiber/carbon fiber composite. The composite material can be summarized as a combination of boron filaments (where boron may be added in various filaments per inch of tape width (fpi), at least between 10 fpi and 900 fpi but often between 52 fpi and 208 fpi), carbon fiber (including various moduli and filament sizes), and resins (typically epoxies, but may include bismaleimide, cyanate ester, or any other resin chemistry). Boron fibers may be introduced at any interval spacing in the prepreg, and at any fibers per inch and any fiber volume. A hybrid preform material composed of carbon fiber prepreg and boron fiber is a performance material for sports rackets. This material is composed of boron fibers, carbon fibers, and a resin matrix. A hybrid preform material composed of carbon fiber prepreg and boron fiber, may in some examples be referred to as Hy-Bor™, as a performance material for pickleball paddles, paddles, padel, tennis rackets, and rackets. This material is a composite composed of carbon fiber, boron fiber, and a resin matrix.

In accordance with the present disclosure, the hybrid boron fiber carbon fiber prepreg is formed as an integrated hybrid material in which the boron filaments and carbon fiber filaments are co-mingled at the fiber level within a single prepreg tape prior to impregnation with the resin matrix. This integrated co-mingled structure differs from approaches that applied discrete boron strips, braids, or plates onto or alongside a separate carbon fiber frame or substrate. The integrated co-mingling of the two fiber types at the individual filament level within the prepreg tape enables the synergistic combination of boron's exceptional compressive strength and stiffness with carbon fiber's tensile properties, resulting in a unitary composite material that exhibits superior overall strength, compressive performance, damping, and explosive strain energy release.

The fiber selection for a composite material fundamentally alters the resulting mechanical performance. Boron fiber has exceptional compression strength and stiffness; paired with carbon fibers, this combination of fibers results in a lightweight yet strong and stiff composite. Hybrid boron fiber carbon fiber prepreg has been selected for use due to its high overall strength and stiffness, superior compressive strength, higher damping coefficient, and more explosive strain energy release. There are multiple configurations in which hybrid boron fiber carbon fiber prepreg can be applied-this material can be used as the face sheet surface, within the layers of the face sheet laminates, in the sweet spot area, in the neck area between the handle and the paddle face, and around the perimeter of the paddle. The expected effects of using hybrid boron fiber carbon fiber prepreg material in these configurations are listed below:

Face sheet surface and/or within face sheet laminate: High stiffness and explosive strain energy release are expected to improve power and pop, and damping coefficient will change the audible frequency of the shot. Noise reduction will be achieved while still maintaining sufficient energy for high power and control. When the sports racket is impacted with a ball, the hybrid boron fiber-carbon fiber prepreg can be configured such that a noise signature of the resulting impact sound is modified relative to a comparison sports racket lacking the hybrid prepreg in the corresponding region under similar impact conditions. In this context, “noise signature” refers to acoustic characteristics of the impact sound beyond overall loudness, including, for example, the frequency spectrum, one or more dominant frequency bands, and/or the temporal decay profile of the impact noise. Sweet spot area: High power and pop area will be localized in the sweet spot. Neck area between handle and paddle/racket face: High stiffness of a hybrid boron fiber carbon fiber prepreg material insert/reinforcement in this area are expected to increase the overall axial stiffness of the paddle/racket, resulting in higher power and improved whip-like feeling. Perimeter of paddle/racket: High stiffness of hybrid boron fiber carbon fiber prepreg material for edge reinforcement and/or frame construction will improve durability of paddle/racket and the torsional stiffness, which will result in higher control and more consistent hand feel.

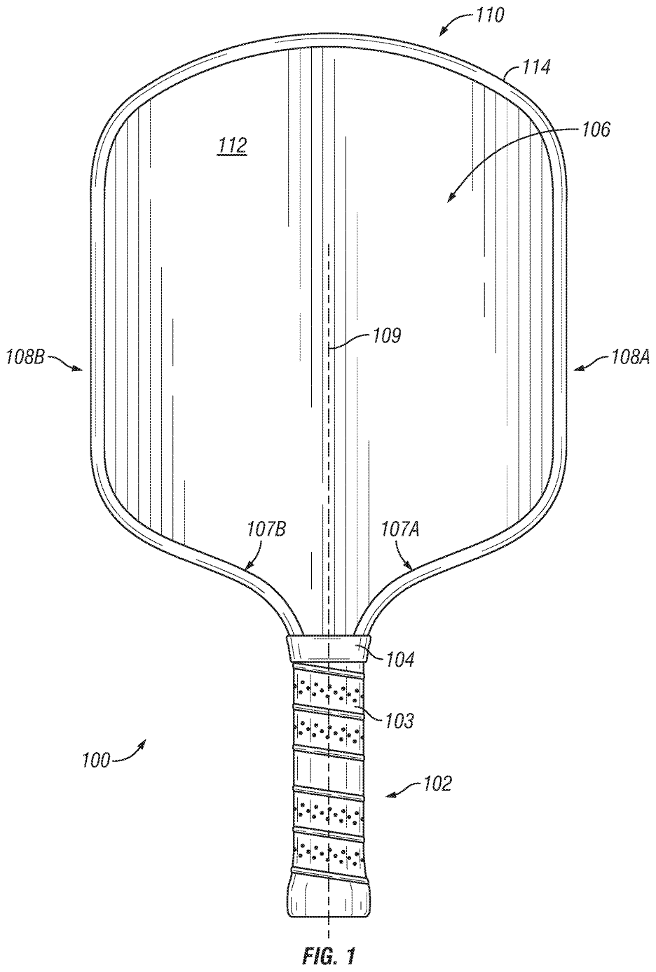

FIG. 1 is a front view of a Sport racket 100 (which may be referred to as a paddle). The sport racket 100 can have a handle 102, and the sport racket body 106. Any portion of the sport racket handle, shaft, head, or frame may be made with a Hy-Bor™ prepreg (may be referred to as a fiber-reinforced composite material). The Hy-Bor™ prepreg may be present in the sports racket in part or in whole; at any layer or in multiple layers of the composite bulk. All of which can be made with a hybrid boron fiber carbon fiber prepreg. The handle 102 can be shaped to allow for a user (not illustrated) to have maximum grip of the sport racket 100. In some examples, there may be a grip wrap or tape 103 that can wrap or engage with the handle 102. This grip wrap or tape 103 can allow a user to select their preference on the type of grip, the shape of the grip, and the stickiness of the grip material. Additionally, there may be different types of grips that can be added to the handle in addition to the grip wrap or tape. It would be understood that while a pickleball paddle is used for illustration purposes, any form of paddle or racket could be utilized. This includes the formation, manufacturer, and/or composition of the paddle or racket, and any sports that may utilize them.

The connection 104 can allow for the coupling of the handle 102 to the sport racket body 106. In some examples, the handle 102 and sport racket body 106 may be made from one material such as but not limited to a hybrid boron fiber carbon fiber prepreg, and the connection point 104 is for decorative purposes. While in other examples, the connection point 104 can be utilized to ensure a solid connection of the handle 102 with the sport racket body 106. While in other examples, the connection point 104 can be used to ensure that the grip wrap or tape 103 is not hindering the sport racket body 106 or its structure. In some examples, a fastener or adhesive may be used to secure the connection 104 to the handle 102 and/or racket body 106. Similarly, there may be a need for a connection 104 to be a ringlike structure that can be replaced with the face, face surface, or face surface laminate, or for cosmetic purposes as well. Regardless, the connection 104 allows for the securing of the handle 102 with the racket body 106, if they are not made of one piece.

The sport racket body 106 may have various changes to its shape to improve performance. For example, the shoulders 107A/107B of the sport racket body 106 may have different curves, arcs, or lines that allow for the perimeter of the sport racket body 106 to be maximized or minimized for the purposes of the sport racket body 106 design. Similarly, because of the positioning and/or shape of the shoulders 107A/107B there can be a change in the sweet spot of the paddle or racket as vibrations and/or harmonics travel through the paddle or racket. This allows for different paddles or rackets to be created for specific playing styles, and/or purposes. The sides 108A/108B, in at least one example, are parallel, while in other examples, there may be an angle in relationship to the center line 109 that runs through the handle 102. In at least one embodiment, the angle for side 108A will be opposite of that for side 108B, for example if the angle for 108A is −5 degrees from the centerline 109, then for side 108B the angle can be 5 degrees. These angles can be any range between −90 and 90 degrees. Then there is the top edge 110 that completes the perimeter of the sport racket body 106. The perimeter of the sport racket body 106 encompasses the sport racket surface 112. The sport racket surface 112 is utilized to strike a pickleball. In at least one embodiment, the sport racket body 106 may include multiple layers of materials, in some examples there may be a single layer while in others there may be hundreds of layers. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 106 may include an edge guard 114 that can protect the edges of the layers that make up the sport racket surface 112. In at least one embodiment, the edge guard 114 is a solid material that is permanently attached to the sport racket body 106 or sport racket surface 114. In some examples, the edge guard 114 may be removable to allow for the sport racket body 106 or sport racket surface 112 to be inspected. While not a common feature, if an edge guard 114 is placed in a manner that the strings or string bed of a racket, or portions of the paddle body pass through the edge guard 114, the edge guard 114 may be made of different materials to trigger different responses from the racket or paddle.

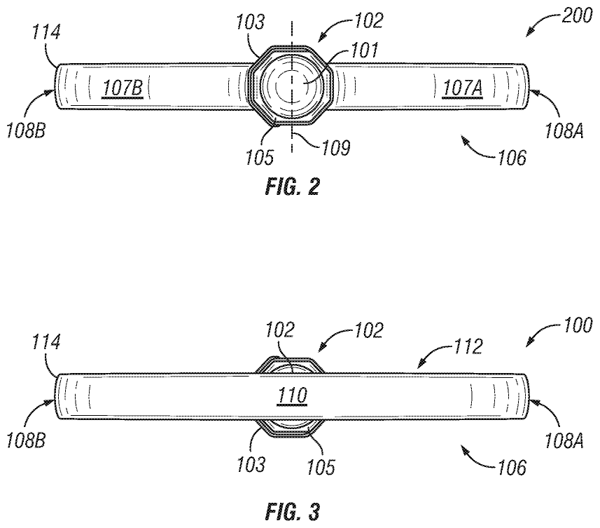

FIG. 2 is a bottom view of the Sport racket 100 (may be referred to as a paddle). The sport racket 100 can have a handle 102, and the sport racket body 106. Any portion of the sport racket handle, shaft, head, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 102 can be shaped to allow for a user (not illustrated) to have maximum grip of the sport racket 100. In some examples, there may be a grip wrap or tape 103 that can wrap or engage with the handle 102. This grip wrap or tape 103 can allow a user to select their preference on the type of grip, the shape of the grip, and the stickiness of the grip material. Additionally, there may be different types of grips that can be added to the handle in addition to the grip wrap or tape.

The sport racket body 106 may have various changes to its shape to improve performance. For example, the shoulders 107A/107B of the sport racket body 106 may have different curves, arcs, or lines that allow for the perimeter of the sport racket body 106 to be maximized or minimized for the purposes of the sport racket body 106 design. The sides 108A/108B, in at least one example, are parallel, while in other examples, there may be an angle in relationship to the center line 109 that runs through the handle 102. In at least one embodiment, the angle for side 108A will be opposite of that for side 108B, for example if the angle for 108A is −5 degrees from the centerline 109, then for side 108B the angle can be 5 degrees. These angles can be any range between −90 and 90 degrees. Then there is the top edge 110 that completes the perimeter of the sport racket body 106. The perimeter of the sport racket body 106 encompasses the sport racket surface 112. In at least one embodiment, the sport racket body 106 may include multiple layers of materials, in some examples there may be a single layer while in others there may be hundreds of layers. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 106 may include an edge guard 114 that can protect the edges of the layers that make up the sport racket surface 112. In at least one embodiment, the edge guard 114 is a solid material that is permanently attached to the sport racket body 106 or sport racket surface 114. In some examples, the edge guard 114 may be removable to allow for the sport racket body 106 or sport racket surface 112 to be inspected.

In some examples, the handle 102 may have a core 101 that has an outer material 105 to allow for shaping of the handle to occur. In other examples, the core 101 and/or outer material 105 can be utilized of different materials that can change the grip or grip pattern for a user. While in other examples, one or both of the core 101 or outer material 105 can be molded to a user's hand or finger shape. The core 101, and/or outer material 105 may include hybrid boron fiber carbon fiber prepreg.

FIG. 3 is a top view of the Sport racket 100 (may be referred to as a paddle). The sport racket 100 can have a handle 102, and the sport racket body 106. Any portion of the sport racket handle, shaft, head, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 102 can be shaped to allow for a user (not illustrated) to have maximum grip of the sports racket 100. In some examples, there may be a grip wrap or tape 103 that can wrap or engage with the handle 102. This grip wrap or tape 103 can allow a user to select their preference on the type of grip, the shape of the grip, and the stickiness of the grip material. Additionally, there may be different types of grips that can be added to the handle in addition to the grip wrap or tape.

The sport racket body 106 may have various changes to its shape to improve performance. The sides 108A/108B, in at least one example, are parallel, while in other examples, there may be an angle in relationship to the center line 109 that runs through the handle 102. In at least one embodiment, the angle for side 108A will be opposite of that for side 108B, for example if the angle for 108A is −5 degrees from the centerline 109, then for side 108B the angle can be 5 degrees. These angles can be any range between −90 and 90 degrees. Then there is the top edge 110 that completes the perimeter of the sport racket body 106. The perimeter of the sport racket body 106 encompasses the sport racket surface 112. The sport racket surface 112 is utilized to strike a pickleball. In at least one embodiment, the sport racket body 106 may include multiple layers of materials, in some examples there may be a single layer while in others there may be hundreds of layers. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 106 may include an edge guard 114 that can protect the edges of the layers that make up the sport racket surface 112. In at least one embodiment, the edge guard 114 is a solid material that is permanently attached to the sport racket body 106 or sport racket surface 114. In some examples, the edge guard 114 may be removable to allow for the sport racket body 106 or sport racket surface 112 to be inspected.

In some examples, the handle 102 may have a core 101 that has an outer material 105 to allow for shaping of the handle to occur. In other examples, the core 101 and/or outer material 105 can be utilized of different materials that can change the grip or grip pattern for a user. While in other examples, one or both of the core 101 or outer material 105 can be molded to a user's hand or finger shape. The core 101, and/or outer material 105 may include a hybrid boron fiber carbon fiber prepreg.

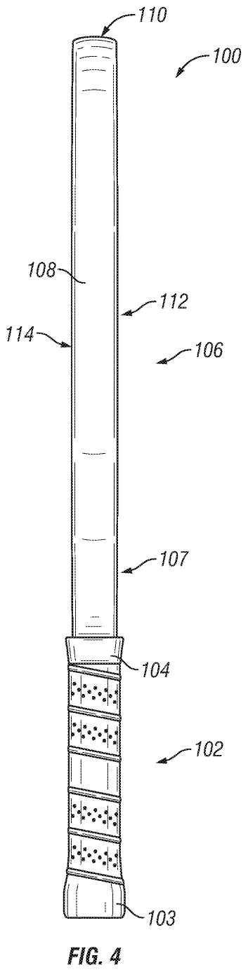

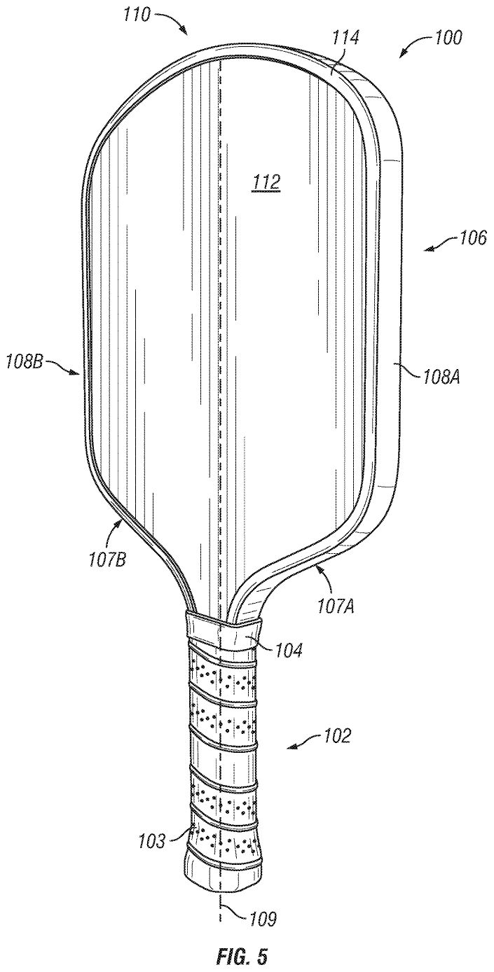

FIG. 4 is a side view of the Sport racket 100 (may be referred to as a paddle). The sport racket 100 can have a handle 102, a connection point 104, and the sport racket body 106. The sport racket 100 can have a handle 102, and the sport racket body 106. Any portion of the sport racket handle, shaft, head, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 102 can be shaped to allow for a user (not illustrated) to have maximum grip of the sport racket 100. In some examples, there may be a grip wrap or tape 103 that can wrap or engage with the handle 102. This grip wrap or tape 103 can allow a user to select their preference on the type of grip, the shape of the grip, and the stickiness of the grip material. Additionally, there may be different types of grips that can be added to the handle in addition to the grip wrap or tape.

The connection 104 can allow for the coupling of the handle 102 to the sport racket body 106. In some examples, the handle 102 and sport racket body 106 may be made from one material, such as but not limited to a hybrid boron fiber carbon fiber prepreg, and the connection point 104 is for decorative purposes. While in other examples, the connection point 104 can be utilized to ensure a solid connection of the handle 102 with the sport racket body 106. While in other examples, the connection point 104 can be used to ensure that the grip wrap or tape 103 is not hindering the sport racket body 106 or its structure. In some examples, a fastener or adhesive may be used to secure the connection 104 to the handle 102 and/or racket body 106. Similarly, there may be a need for a connection 104 to be a ringlike structure that can be replaced with the face, face surface, or face surface laminate, or for cosmetic purposes as well. Regardless, the connection 104 allows for the securing of the handle 102 with the racket body 106, if they are not made of one piece.

The sport racket body 106 may have various changes to its shape to improve performance. For example, the shoulders 107 of the sport racket body 106 may have different curves, arcs, or lines that allow for the perimeter of the sport racket body 106 to be maximized or minimized for the purposes of the sport racket body 106 design. Similarly, because of the positioning and/or shape of the shoulders 107 there can be a change in the sweet spot of the paddle or racket as vibrations and/or harmonics travel through the paddle or racket. This allows for different paddles or rackets to be created for specific playing styles, and/or purposes. Then there is the top edge 110 that completes the perimeter of the sport racket body 106. The perimeter of the sport racket body 106 encompasses the sport racket surface 112. The sport racket surface 112 is utilized to strike a pickleball. In at least one embodiment, the sport racket body 106 may include multiple layers of materials, in some examples there may be a single layer while in others there may be hundreds of layers.

A perimeter of the sport racket body 106 may include an edge guard 114 that can protect the edges of the layers that make up the sport racket surface 112. In at least one embodiment, the edge guard 114 is a solid material that is permanently attached to the sport racket body 106 or sport racket surface 114. In some examples, the edge guard 114 may be removable to allow for the sport racket body 106 or sport racket surface 112 to be inspected. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

FIG. 5 is side perspective view of the Sport racket 100 (may be referred to as a paddle). The sport racket 100 can have a handle 102, a connection point 104, and the sport racket body 106. The sport racket 100 can have a handle 102, and the sport racket body 106. Any portion of the sport racket handle, shaft, head, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 102 can be shaped to allow for a user (not illustrated) to have maximum grip of the sport racket 100. In some examples, there may be a grip wrap or tape 103 that can wrap or engage with the handle 102. This grip wrap or tape 103 can allow a user to select their preference on the type of grip, the shape of the grip, and the stickiness of the grip material. Additionally, there may be different types of grips that can be added to the handle in addition to the grip wrap or tape.

The connection 104 can allow for the coupling of the handle 102 to the sport racket body 106. In some examples, the handle 102 and sport racket body 106 may be made from one material, such as but not limited to a hybrid boron fiber carbon fiber composite material, and the connection point 104 is for decorative purposes. Boron fibers can be incorporated into carbon fiber prepreg to tailor the material characteristics and performance of the final hybrid boron fiber carbon fiber composite. The composite material can be summarized as a combination of boron filaments (where boron may be added in various filaments per inch of tape width (fpi), at least between 10 fpi and 900 fpi and most often between 52 fpi and 208 fpi), carbon fiber (including various moduli and filament sizes), and resins (typically epoxies, but may include bismaleimide, cyanate ester, or any other resin chemistry). Boron fibers may be introduced at any interval spacing in the prepreg, and at any fibers per inch and any fiber volume. While in other examples, the connection point 104 can be utilized to ensure a solid connection of the handle 102 with the sport racket body 106. While in other examples, the connection point 104 can be used to ensure that the grip wrap or tape 103 is not hindering the sport racket body 106 or its structure. In some examples, a fastener or adhesive may be used to secure the connection 104 to the handle 102 and/or racket body 106. Similarly, there may be a need for a connection 104 to be a ringlike structure that can be replaced with the face, face surface, or face surface laminate, or for cosmetic purposes as well. Regardless, the connection 104 allows for the securing of the handle 102 with the racket body 106, if they are not made of one piece.

The sport racket body 106 may have various changes to its shape to improve performance. For example, the shoulders 107A/107B of the sport racket body 106 may have different curves, arcs, or lines that allow for the perimeter of the sport racket body 106 to be maximized or minimized for the purposes of the sport racket body 106 design. Similarly, because of the positioning and/or shape of the shoulders 107A/107B there can be a change in the sweet spot of the paddle or racket as vibrations and/or harmonics travel through the paddle or racket. This allows for different paddles or rackets to be created for specific playing styles, and/or purposes. The sides 108A/108B, in at least one example, are parallel, while in other examples, there may be an angle in relationship to the center line 109 that runs through the handle 102. In at least one embodiment, the angle for side 108A will be opposite of that for side 108B, for example if the angle for 108A is −5 degrees from the centerline 109, then for side 108B the angle can be 5 degrees. These angles can be any range between −90 and 90 degrees. Then there is the top edge 110 that completes the perimeter of the sport racket body 106. The perimeter of the sport racket body 106 encompasses the sport racket surface 112. The sport racket surface 112 is utilized to strike a pickleball. In at least one embodiment, the sport racket body 106 may include multiple layers of materials, in some examples there may be a single layer while in others there may be hundreds of layers. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 106 may include an edge guard 114 that can protect the edges of the layers that make up the sport racket surface 112. In at least one embodiment, the edge guard 114 is a solid material that is permanently attached to the sport racket body 106 or sport racket surface 114. In some examples, the edge guard 114 may be removable to allow for the sport racket body 106 or sport racket surface 112 to be inspected. While not a common feature, if an edge guard 114 is placed in a manner that the strings or string bed of a racket, or portions of the paddle body pass through the edge guard 114, the edge guard 114 may be made of different materials to trigger different responses from the racket or paddle.

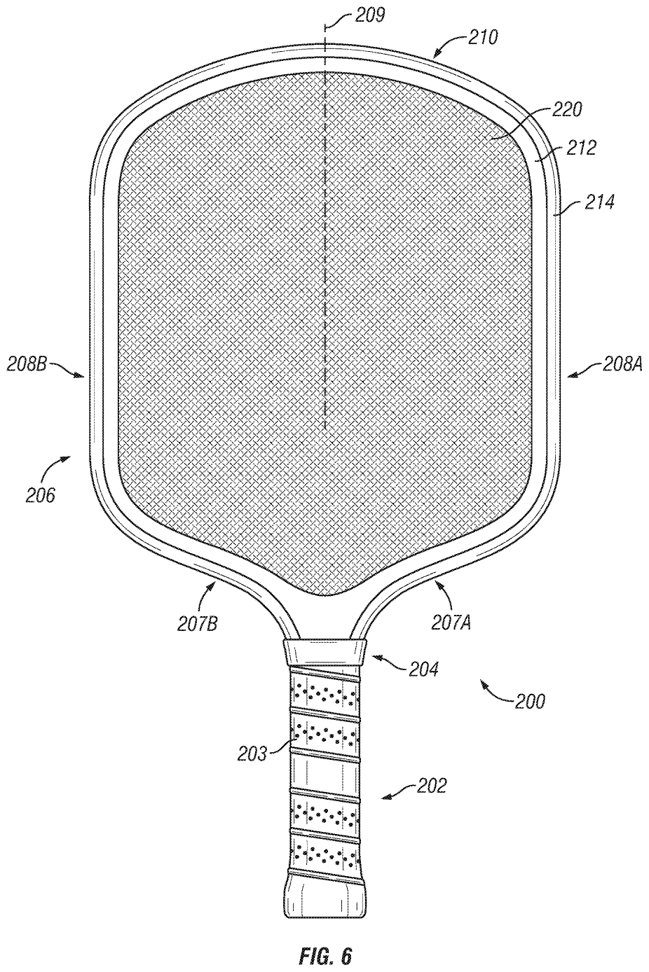

FIG. 6 is front view of the Sport racket 200 (may be referred to as a paddle). The sport racket 200 can have a handle 202, a connection point 204, and the sport racket body 206. The sport racket 200 can have a handle 202, and the sport racket body 206. Any portion of the sport racket handle, shaft, head, or frame may be made with a Hy-Bor™ prepreg (may be referred to as a fiber-reinforced composite material). The Hy-Bor™ prepreg may be present in the sports racket in part or in whole; at any layer or in multiple layers of the composite bulk. All of which can be made with a hybrid boron fiber carbon fiber prepreg. The handle 202 can be shaped to allow for a user (not illustrated) to have maximum grip of the sport racket 200. In some examples, there may be a grip wrap or tape 203 that can wrap or engage with the handle 202. This grip wrap or tape 203 can allow a user to select their preference on the type of grip, the shape of the grip, and the stickiness of the grip material. Additionally, there may be different types of grips that can be added to the handle in addition to the grip wrap or tape.

The connection 204 can allow for the coupling of the handle 202 to the sport racket body 206. In some examples, the handle 202 and sport racket body 206 may be made from one material, such as but not limited to a hybrid boron fiber carbon fiber composite material, and the connection point 204 is for decorative purposes. While in other examples, the connection point 204 can be utilized to ensure a solid connection of the handle 202 with the sport racket body 206. While in other examples, the connection point 204 can be used to ensure that the grip wrap or tape 203 is not hindering the sport racket body 206 or its structure. In some examples, a fastener or adhesive may be used to secure the connection 204 to the handle 202 and/or racket body 206. Similarly, there may be a need for a connection 204 to be a ringlike structure that can be replaced with the face, face surface, or face surface laminate, or for cosmetic purposes as well. Regardless, the connection 204 allows for the securing of the handle 202 with the racket body 206, if they are not made of one piece.

The sport racket body 206 may have various changes to its shape to improve performance. For example, the shoulders 207A/207B of the sport racket body 206 may have different curves, arcs, or lines that allow for the perimeter of the sport racket body 206 to be maximized or minimized for the purposes of the sport racket body 206 design. Similarly, because of the positioning and/or shape of the shoulders 207A/207B there can be a change in the sweet spot of the paddle or racket as vibrations and/or harmonics travel through the paddle or racket. This allows for different paddles or rackets to be created for specific playing styles, and/or purposes. The sides 208A/208B, in at least one example, are parallel, while in other examples, there may be an angle in relationship to the center line 209 that runs through the handle 202. In at least one embodiment, the angle for side 208A will be opposite of that for side 208B, for example if the angle for 208A is −5 degrees from the centerline 209, then for side 208B the angle can be 5 degrees. These angles can be any range between −90 and 90 degrees. Then there is the top edge 210 that completes the perimeter of the sport racket body 206. The perimeter of the sport racket body 206 encompasses the sport racket surface 212. The sport racket surface 212 is utilized to strike a pickleball. In at least one embodiment, the sport racket body 206 may include multiple layers of materials, in some examples there may be a single layer while in others there may be hundreds of layers. At least one of these layers may include hybrid boron fiber carbon fiber prepreg. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 206 may include an edge guard 214 that can protect the edges of the layers that make up the sport racket surface 212. In at least one embodiment, the edge guard 214 is a solid material that is permanently attached to the sport racket body 206 or sport racket surface 214. In some examples, the edge guard 214 may be removable to allow for the sport racket body 206 or sport racket surface 212 to be inspected. The sport racket surface 212 may include a covering 220. In some examples, a covering 220 may be utilized to change the strike point and/or power of the sport racket 200, by including a hybrid boron fiber carbon fiber prepreg layer that can be placed on top and/or incorporated with a sport racket made of different materials or compositions of materials. The covering 220 may be coupled to the sport racket surface 212 through a hook and loop coupling, a glue or fluid based coupling, or may possibly include a coupling to the edge guard 214. While the covering 220 may be engaged directly with the sport racket surface 212, there may be times when the covering 220 may be more like cartridge. In an example, like this one, that may look like the covering 220 and a set of edges or wings that can engage with the edge guard 214 to secure the covering 220 in place during play. This can allow the covering 220 to be removable. Providing an advantage that the user can have the same paddle for both indoor and outdoor play. While not a common feature, if an edge guard 214 is placed in a manner that the strings or string bed of a racket, or portions of the paddle body pass through the edge guard 214, the edge guard 214 may be made of different materials to trigger different responses from the racket or paddle.

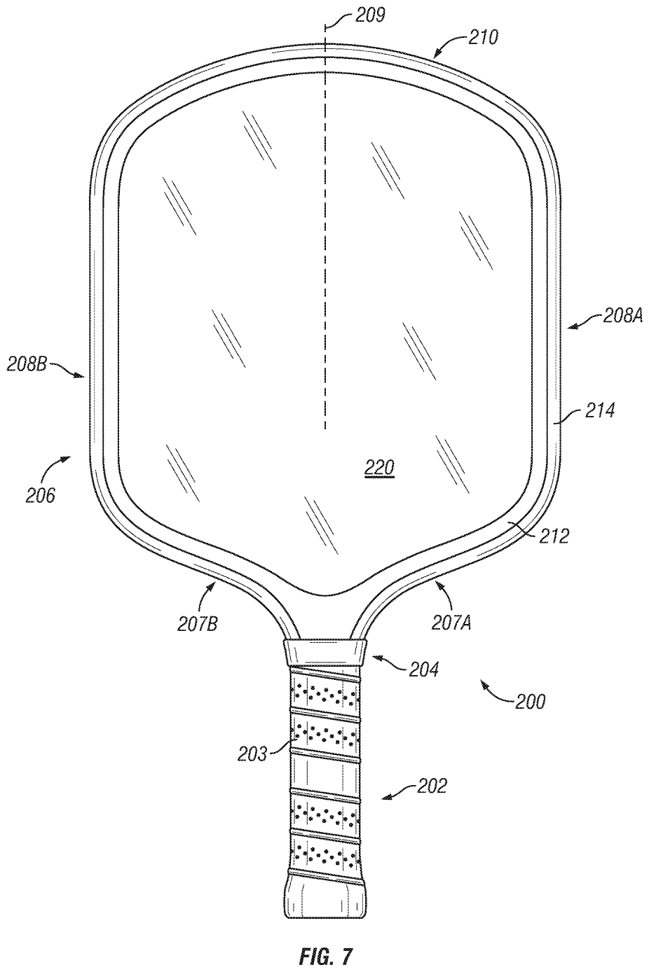

FIG. 7 is front view of the Sport racket 200 (may be referred to as a paddle). The sport racket 200 can have a handle 202, a connection point 204, and the sport racket body 206. The sport racket 200 can have a handle 202, and the sport racket body 206. Any portion of the sport racket handle, shaft, head, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 202 can be shaped to allow for a user (not illustrated) to have maximum grip of the sport racket 200. In some examples, there may be a grip wrap or tape 203 that can wrap or engage with the handle 202. This grip wrap or tape 203 can allow a user to select their preference on the type of grip, the shape of the grip, and the stickiness of the grip material. Additionally, there may be different types of grips that can be added to the handle in addition to the grip wrap or tape.

The connection 204 can allow for the coupling of the handle 202 to the sport racket body 206. In some examples, the handle 202 and sport racket body 206 may be made from one material, such as but not limited to a hybrid boron fiber carbon fiber prepreg, and the connection point 204 is for decorative purposes. While in other examples, the connection point 204 can be utilized to ensure a solid connection of the handle 202 with the sport racket body 206. While in other examples, the connection point 204 can be used to ensure that the grip wrap or tape 203 is not hindering the sport racket body 206 or its structure. In some examples, a fastener or adhesive may be used to secure the connection 204 to the handle 202 and/or racket body 206. Similarly, there may be a need for a connection 204 to be a ringlike structure that can be replaced with the face, face surface, or face surface laminate, or for cosmetic purposes as well. Regardless, the connection 204 allows for the securing of the handle 202 with the racket body 206, if they are not made of one piece.

The sport racket body 206 may have various changes to its shape to improve performance. For example, the shoulders 207A/207B of the sport racket body 206 may have different curves, arcs, or lines that allow for the perimeter of the sport racket body 206 to be maximized or minimized for the purposes of the sport racket body 206 design. Similarly, because of the positioning and/or shape of the shoulders 207A/207B there can be a change in the sweet spot of the paddle or racket as vibrations and/or harmonics travel through the paddle or racket. This allows for different paddles or rackets to be created for specific playing styles, and/or purposes. The sides 208A/208B, in at least one example, are parallel, while in other examples, there may be an angle in relationship to the center line 209 that runs through the handle 202. In at least one embodiment, the angle for side 208A will be opposite of that for side 208B, for example if the angle for 208A is −5 degrees from the centerline 209, then for side 208B the angle can be 5 degrees. These angles can be any range between −90 and 90 degrees. Then there is the top edge 210 that completes the perimeter of the sport racket body 206. The perimeter of the sport racket body 206 encompasses the sport racket surface 212. The sport racket surface is utilized to strike a pickleball. In at least one embodiment, the sport racket body 206 may include multiple layers of materials, in some examples there may be a single layer while in others there may be hundreds of layers. At least one of these layer can include a hybrid boron fiber carbon fiber prepreg. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 206 may include an edge guard 214 that can protect the edges of the layers that make up the sport racket surface 212. In at least one embodiment, the edge guard 214 is a solid material that is permanently attached to the sport racket body 206 or sport racket surface 214. In some examples, the edge guard 214 may be removable to allow for the sport racket body 206 or sport racket surface 212 to be inspected. The sport racket surface 212 may include a covering 220. In some examples, a covering 220 may be utilized to change the strike point and/or power of the sport racket 200, by including a hybrid boron fiber carbon fiber prepreg layer that can be placed on top and/or incorporated with a sport racket made of different materials or compositions of materials. The covering 220 may be coupled to the sport racket surface 212 through a hook and loop coupling, a glue or fluid based coupling, or may possibly include a coupling to the edge guard 214. While the covering 220 may be engaged directly with the sport racket surface 212, there may be times when the covering 220 may be more like cartridge. In an example, like this one, that may look like the covering 220 and a set of edges or wings that can engage with the edge guard 214 to secure the covering 220 in place during play. This can allow the covering 220 to be removable. Providing an advantage that the user can have the same sport racket for both indoor and outdoor play. While not a common feature, if an edge guard 214 is placed in a manner that the strings or string bed of a racket, or portions of the paddle body pass through the edge guard 214, the edge guard 214 may be made of different materials to trigger different responses from the racket or paddle.

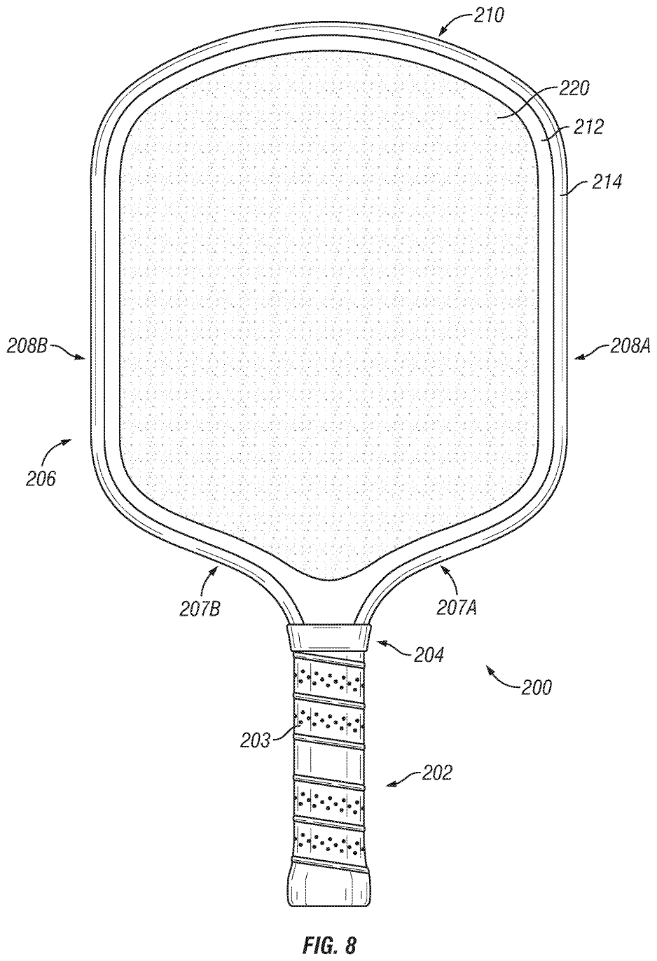

FIG. 8 is front view of the Sport racket 200 (may be referred to as a paddle). The sport racket 200 can have a handle 202, a connection point 204, and the sport racket body 206. The sport racket 200 can have a handle 202, and the sport racket body 206. Any portion of the sport racket handle, shaft, head, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 202 can be shaped to allow for a user (not illustrated) to have maximum grip of the sport racket 200. In some examples, there may be a grip wrap or tape 203 that can wrap or engage with the handle 202. This grip wrap or tape 203 can allow a user to select their preference on the type of grip, the shape of the grip, and the stickiness of the grip material. Additionally, there may be different types of grips that can be added to the handle in addition to the grip wrap or tape.

The connection 204 can allow for the coupling of the handle 202 to the sport racket body 206. In some examples, the handle 202 and sport racket body 206 may be made from one material, such as but not limited to a hybrid boron fiber carbon fiber composite material, and the connection point 204 is for decorative purposes. While in other examples, the connection point 204 can be utilized to ensure a solid connection of the handle 202 with the sport racket body 206. While in other examples, the connection point 204 can be used to ensure that the grip wrap or tape 203 is not hindering the sport racket body 206 or its structure. In some examples, a fastener or adhesive may be used to secure the connection 204 to the handle 202 and/or racket body 206. Similarly, there may be a need for a connection 204 to be a ringlike structure that can be replaced with the face, face surface, or face surface laminate, or for cosmetic purposes as well. Regardless, the connection 204 allows for the securing of the handle 202 with the racket body 206, if they are not made of one piece.

The sport racket body 206 may have various changes to its shape to improve performance. For example, the shoulders 207A/207B of the sport racket body 206 may have different curves, arcs, or lines that allow for the perimeter of the sport racket body 206 to be maximized or minimized for the purposes of the sport racket body 206 design. Similarly, because of the positioning and/or shape of the shoulders 207A/207B there can be a change in the sweet spot of the paddle or racket as vibrations and/or harmonics travel through the paddle or racket. This allows for different paddles or rackets to be created for specific playing styles, and/or purposes. The sides 208A/208B, in at least one example, are parallel, while in other examples, there may be an angle in relationship to the center line 209 that runs through the handle 202. In at least one embodiment, the angle for side 208A will be opposite of that for side 208B, for example if the angle for 208A is −5 degrees from the centerline 209, then for side 208B the angle can be 5 degrees. These angles can be any range between −90 and 90 degrees. Then there is the top edge 210 that completes the perimeter of the sport racket body 206. The perimeter of the sport racket body 206 encompasses the sport racket surface 212. The sport racket surface 212 is utilized to strike a pickleball. In at least one embodiment, the sport racket body 206 may include multiple layers of materials, in some examples there may be a single layer while in others there may be hundreds of layers. At least one of these layer can include a hybrid boron fiber carbon fiber prepreg. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 206 may include an edge guard 214 that can protect the edges of the layers that make up the sport racket surface 212. In at least one embodiment, the edge guard 214 is a solid material that is permanently attached to the sport racket body 106 or sport racket surface 214. In some examples, the edge guard 214 may be removable to allow for the sport racket body 206 or sport racket surface 212 to be inspected. The sport racket surface 212 may include a covering 220. In some examples, a covering 220 may be utilized to change the strike point and/or power of the sport racket 200, by including a hybrid boron fiber carbon fiber prepreg layer that can be placed on top and/or incorporated with a sport racket made of different materials or compositions of materials. The covering 220 may be coupled to the sport racket surface 212 through a hook and loop coupling, a glue or fluid based coupling, or may possibly include a coupling to the edge guard 214. While the covering 220 may be engaged directly with the sport racket surface 212, there may be times when the covering 220 may be more like cartridge. In an example, like this one, that may look like the covering 220 and a set of edges or wings that can engage with the edge guard 214 to secure the covering 220 in place during play. This can allow the covering 220 to be removable. Providing an advantage that the user can have the same paddle for both indoor and outdoor play. The coverings discussed herein may also allow for changes to the particular skills needed by a player. For example, there can be changes to the spin of the pickleball after being struck when the sport racket surface has a covering. Additionally, if the coverings are allowed to be removable then it can allow for increased lifetime of the sport racket overall. While not a common feature, if an edge guard 214 is placed in a manner that the strings or string bed of a racket, or portions of the paddle body pass through the edge guard 214, the edge guard 214 may be made of different materials to trigger different responses from the racket or paddle.

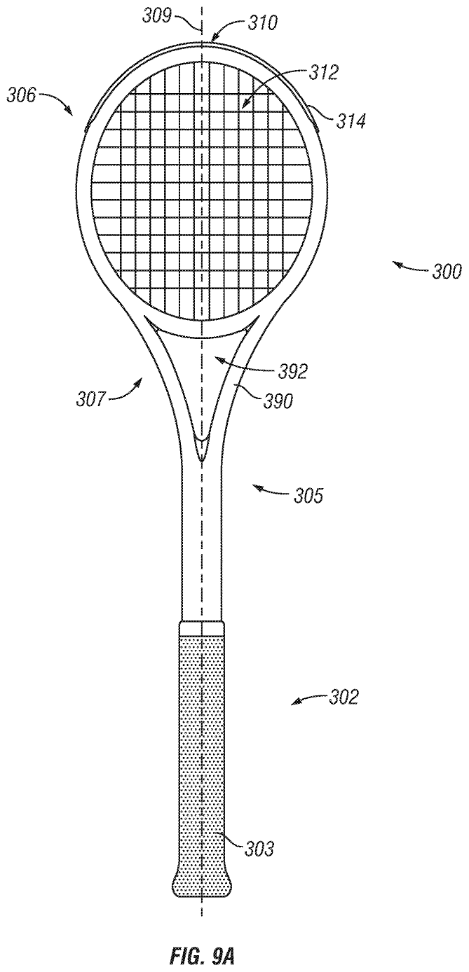

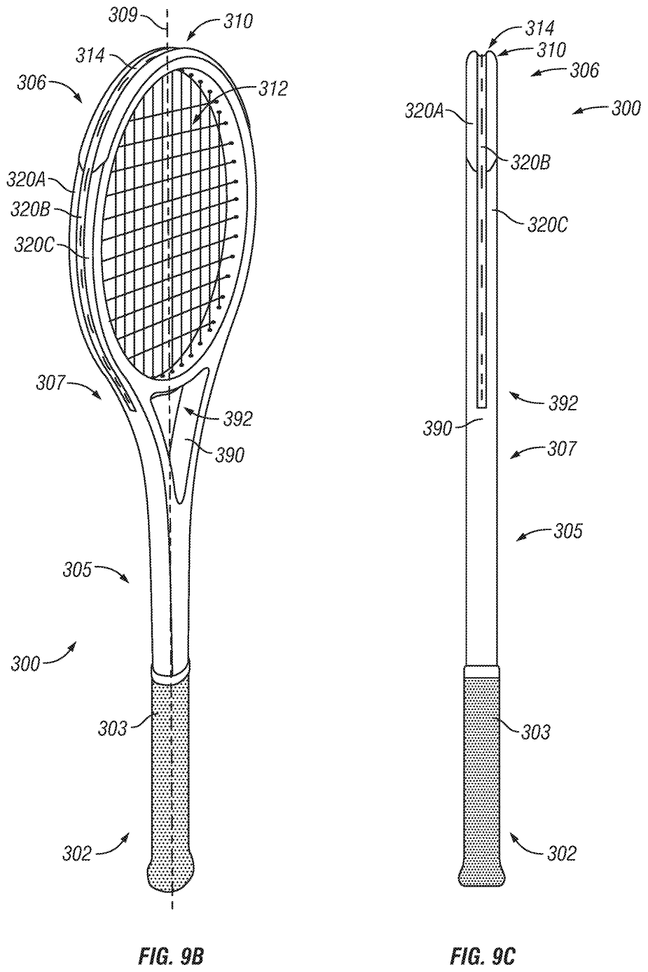

FIG. 9A is a front view of a small badminton or tennis racket referred to as sports racket 300 (may be referred to as a paddle). The sport racket 300 can have a handle 302, a connection shaft 305, the sport racket body 306, and racket split 307. Any portion of the sport racket handle, shaft, head, body, split, or frame may be made with a Hy-Bor™ prepreg (may be referred to as a fiber-reinforced composite material). The Hy-Bor™ prepreg may be present in the sports racket in part or in whole; at any layer or in multiple layers of the composite bulk. All of which can be made with a hybrid boron fiber carbon fiber prepreg. The handle 302 can be shaped to allow for a user (not illustrated) to have maximum grip of the sport racket 300. In some examples, there may be a grip wrap or tape 303 that can wrap or engage with the handle 302. This grip wrap or tape 303 can allow a user to select their preference on the type of grip, the shape of the grip, and the stickiness of the grip material. Additionally, there may be different types of grips that can be added to the handle in addition to the grip wrap or tape.

The connection shaft 305 can allow for the coupling of the handle 302 to the sport racket body 306. In some examples, the handle 302 and sport racket body 306 may be made from one material, such as but not limited to a hybrid boron fiber carbon fiber composite material, and the connection shaft 305 and/or racket split 307 is for decorative purposes. While in other examples, the connection shaft 305 can be utilized to ensure a solid connection of the handle 302 with the sport racket body 306. While in other examples, the connection shaft 305 can be used to ensure that the grip wrap or tape 303 is not hindering the sport racket body 306 or its structure. In some examples, a fastener or adhesive may be used to secure the connection 304 to the handle 302 and/or racket body 306. Similarly, there may be a need for a connection 304 to be a ringlike structure that can be replaced with the face, face surface, or face surface laminate, or for cosmetic purposes as well. Regardless, the connection 304 allows for the securing of the handle 302 with the racket body 306, if they are not made of one piece.

As used herein, racket split may also be referred to as a shoulder or shoulders and is intended to be used in its broadest sense and refers to the structural transition region between the handle or shaft and the head or body of the sports racket (may be referenced to as racket body). Depending on the specific type of racket, ‘shoulders’ may also be referred to, or further comprise, a yoke, a throat, a neck, or a racket split (or a combination thereof any one or more these pieces). These terms are used interchangeably to describe the structural area that may include different curves, arcs, or lines designed to maximize or minimize the perimeter of the sport racket body, define the sweet spot, and manage vibrations or harmonics traveling through the racket. In a tennis racket embodiment, the shoulders may specifically include a yoke and throat that form part of a closed loop frame supporting a string bed. A yoke 390 may allow for a coupling to occur at the racket body 306, while the throat 392 couples to the handle 302 and/or connection shaft 305.

The sport racket body 306 may have various changes to its shape to improve performance. In some examples the sport racket body 306 may be included as part of the head and/or frame. It may be noted that some may consider the head to be where the strings are weaved between the frame portions, where the sport racket body 306 is part of the frame which may also include the racket split 307, connection shaft 305, and/or handle 302. For example, the racket split 307 of the sport racket body 306 may have different curves, arcs, or lines that allow for the perimeter of the sport racket body 306 to be maximized or minimized for the purposes of the sport racket body 306 design. Similarly, because of the positioning and/or shape of the shoulders 307 there can be a change in the sweet spot of the paddle or racket as vibrations and/or harmonics travel through the paddle or racket. This allows for different paddles or rackets to be created for specific playing styles, and/or purposes. The sport racket body 306, in at least one example, is symmetrical, while in other examples, there may be an offset in relationship to the center line 309 that runs through the handle 302. Then there is the top 310 that completes the perimeter of the sport racket body 306. The perimeter of the sport racket body 306 encompasses the sport racket surface 312 (in some examples the racket surface is the strings or a solid surface depending on the sport). The sport racket surface 312 is utilized to strike a ball or shuttlecock, or other item). In at least one embodiment, the sport racket body 306 may include multiple layers of materials, in some examples there may be a single layer while in others there may be hundreds of layers. At least one of these layer can include a hybrid boron fiber carbon fiber prepreg. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 306 may include an edge guard 314 that can protect the edges of the layers, body, and/or frame that connect to the sport racket surface 312. In at least one embodiment, the edge guard 314 is a solid material that is permanently attached to the sport racket body 306 or sport racket surface 312. In some examples, the edge guard 314 may be removable to allow for the sport racket body 306 or sport racket surface 312 to be inspected. While not a common feature, if an edge guard 314 is placed in a manner that the strings or string bed of a racket, or portions of the paddle body pass through the edge guard 314, the edge guard 314 may be made of different materials to trigger different responses from the racket or paddle.

It should be noted that when a frame or sport racket body 306 is utilized and manufactured using a fiber-reinforced composite material, there can be additional benefits based on the string bed or sport racket surface 312. Due to the rigidity and/or flexibility of the fiber-reinforced composite material there can be various improvements to performance of the sports racket. For example, if more energy can be provided to the ball (rebound) or other target, then a player can benefit. By using the fiber-reinforced composite material to reduce or increase frame material damping, and/or various frictions (strings, grommets, etc.) at appropriate points, the boundary condition can be set to maximize performance. The fiber-reinforced composite material can be modified to improve the stiffness and deformation of the sport racket body 306 and/or sport racket surface 312. Similarly, by using various layers of fiber-reinforced composite material to address grommet, drill, and body load points either by reinforcement or a material reduction in those locations, other design benefits may also be achieved. With changes to the bending stiffness and/or torsional stiffness a sport racket can be made more uniform and also return or settle quicker after a target is hit, allowing a user to return to control more quickly and in a more uniform manner.

FIG. 9B is a side perspective view of a small badminton or tennis racket referred to as sports racket 300 (may be referred to as a paddle). The sport racket 300 can have a handle 302, a connection shaft 305, the sport racket body 306, and racket split 307. Any portion of the sport racket handle, shaft, head, body, split, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 302 can be shaped to allow for a user (not illustrated) to have maximum grip of the sport racket 300. In some examples, there may be a grip wrap or tape 303 that can wrap or engage with the handle 302. This grip wrap or tape 303 can allow a user to select their preference on the type of grip, the shape of the grip, and the stickiness of the grip material. Additionally, there may be different types of grips that can be added to the handle in addition to the grip wrap or tape.

The connection shaft 305 can allow for the coupling of the handle 302 to the sport racket body 306. In some examples, the handle 302 and sport racket body 306 may be made from one material, such as but not limited to a hybrid boron fiber carbon fiber composite material, and the connection shaft 305 and/or racket split 307 is for decorative purposes. While in other examples, the connection shaft 305 can be utilized to ensure a solid connection of the handle 302 with the sport racket body 306. While in other examples, the connection shaft 305 can be used to ensure that the grip wrap or tape 303 is not hindering the sport racket body 306 or its structure. In some examples, a fastener or adhesive may be used to secure the connection 304 to the handle 302 and/or racket body 306. Similarly, there may be a need for a connection 304 to be a ringlike structure that can be replaced with the face, face surface, or face surface laminate, or for cosmetic purposes as well. Regardless, the connection 304 allows for the securing of the handle 302 with the racket body 306, if they are not made of one piece.

As used herein, racket split may also be referred to as a shoulder or shoulders and is intended to be used in its broadest sense and refers to the structural transition region between the handle or shaft and the head or body of the sports racket (may be referenced to as racket body). Depending on the specific type of racket, ‘shoulders’ may also be referred to, or further comprise, a yoke, a throat, a neck, or a racket split (or a combination thereof any one or more these pieces). These terms are used interchangeably to describe the structural area that may include different curves, arcs, or lines designed to maximize or minimize the perimeter of the sport racket body, define the sweet spot, and manage vibrations or harmonics traveling through the racket. In a tennis racket embodiment, the shoulders may specifically include a yoke and throat that form part of a closed loop frame supporting a string bed. A yoke 390 may allow for a coupling to occur from the racket body 306, to the handle 302 and/or connection shaft 305, while the throat 392 assists in providing a space between those elements. The throat 392 may in some examples be designed to allow for changes in a user/player's handling of the racket during various types of swings or hits, as well as allowing for changes to the sweet spot, vibrations and/or harmonics of the sport racket.

The sport racket body 306 may have various changes to its shape to improve performance. In some examples the sport racket body 306 may be included as part of the head and/or frame. It may be noted that some may consider the head to be where the strings are weaved between the frame portions, where the sport racket body 306 is part of the frame which may also include the racket split 307, connection shaft 305, and/or handle 302. For example, the racket split 307 of the sport racket body 306 may have different curves, arcs, or lines that allow for the perimeter of the sport racket body 306 to be maximized or minimized for the purposes of the sport racket body 306 design. Similarly, because of the positioning and/or shape of the shoulders 307 there can be a change in the sweet spot of the paddle or racket as vibrations and/or harmonics travel through the paddle or racket. This allows for different paddles or rackets to be created for specific playing styles, and/or purposes. The sport racket body 306, in at least one example, are symmetrical, while in other examples, there may be an offset in relationship to the center line 309 that runs through the handle 302. Then there is the top 310 that completes the perimeter of the sport racket body 306. The perimeter of the sport racket body 306 encompasses the sport racket surface 312 (in some examples the racket surface is the strings or a solid surface depending on the sport). The sport racket surface 312 is utilized to strike a ball or shuttlecock, or other item). In at least one embodiment, the sport racket body 306 may include multiple layers of materials, in some examples there may be a single layer while in others there may be hundreds of layers. At least one of these layer can include a hybrid boron fiber carbon fiber prepreg. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 306 may include an edge guard 314 that can protect the edges of the layers, body, and/or frame that connect to the sport racket surface 312. In at least one embodiment, the edge guard 314 is a solid material that is permanently attached to the sport racket body 306 or sport racket surface 312. In some examples, the edge guard 314 may be removable to allow for the sport racket body 306 or sport racket surface 312 to be inspected. In some examples, the sport racket body 306 may allow for there to be layers such as a first layer 320A, a second or middle layer 320B, and/or a third or final layer 320C that are manufactured of similar or different materials. For example, in one example the first and third layers 320A/320C are made with a Hy-Bor™ prepreg, while the second or middle layer 320B is manufactured of a material that allows for desired or maximum efficiency for the racket surface 312 to be engaged. In other examples, the order of the material may be different, or have different effectiveness to achieve athlete goals. While not a common feature, if an edge guard 314 is placed in a manner that the strings or string bed of a racket, or portions of the paddle body pass through the edge guard 314, the edge guard 314 may be made of different materials to trigger different responses from the racket or paddle.

It should be noted for a second time that when a frame or sport racket body 306 is utilized and manufactured using a fiber-reinforced composite material, there can be additional benefits based on the string bed or sport racket surface 312. Due to the rigidity and/or flexibility of the fiber-reinforced composite material there can be various improvements to performance of the sports racket. For example, if more energy can be provided to the ball (rebound) or other target, then a player can benefit. By using the fiber-reinforced composite material to reduce or increase frame material damping, and/or various frictions (strings, grommets, etc.) at appropriate points, the boundary condition can be set to maximize performance. The fiber-reinforced composite material can be modified to improve the stiffness and deformation of the sport racket body 306 and/or sport racket surface 312. Similarly, by using various layers of fiber-reinforced composite material to address grommet, drill, and body load points either by reinforcement or a material reduction in those locations, other design benefits may also be achieved. With changes to the bending stiffness and/or torsional stiffness a sport racket can be made more uniform and also return or settle quicker after a target is hit, allowing a user to return to control more quickly and in a more uniform manner.

FIG. 9C is a side view of a small badminton or tennis racket referred to as sports racket 300 (may be referred to as a paddle). The sport racket 300 can have a handle 302, a connection shaft 305, the sport racket body 306, and racket split 307. Any portion of the sport racket handle, shaft, head, body, split, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 302 can be shaped to allow for a user (not illustrated) to have maximum grip of the sport racket 300. In some examples, there may be a grip wrap or tape 303 that can wrap or engage with the handle 302. This grip wrap or tape 303 can allow a user to select their preference on the type of grip, the shape of the grip, and the stickiness of the grip material. Additionally, there may be different types of grips that can be added to the handle in addition to the grip wrap or tape.

The connection shaft 305 can allow for the coupling of the handle 302 to the sport racket body 306. In some examples, the handle 302 and sport racket body 306 may be made from one material, such as but not limited to a hybrid boron fiber carbon fiber composite material, and the connection shaft 305 and/or racket split 307 is for decorative purposes. While in other examples, the connection shaft 305 can be utilized to ensure a solid connection of the handle 302 with the sport racket body 306. While in other examples, the connection shaft 305 can be used to ensure that the grip wrap or tape 303 is not hindering the sport racket body 306 or its structure. In some examples, a fastener or adhesive may be used to secure the connection 304 to the handle 302 and/or racket body 306. Similarly, there may be a need for a connection 304 to be a ringlike structure that can be replaced with the face, face surface, or face surface laminate, or for cosmetic purposes as well. Regardless, the connection 304 allows for the securing of the handle 302 with the racket body 306, if they are not made of one piece.

As used herein, racket split may also be referred to as a shoulder or shoulders and is intended to be used in its broadest sense and refers to the structural transition region between the handle or shaft and the head or body of the sports racket (may be referenced to as racket body). Depending on the specific type of racket, ‘shoulders’ may also be referred to, or further comprise, a yoke, a throat, a neck, or a racket split (or a combination thereof any one or more these pieces). These terms are used interchangeably to describe the structural area that may include different curves, arcs, or lines designed to maximize or minimize the perimeter of the sport racket body, define the sweet spot, and manage vibrations or harmonics traveling through the racket. In a tennis racket embodiment, the shoulders may specifically include a yoke and throat that form part of a closed loop frame supporting a string bed. A yoke 390 may allow for a coupling to occur from the racket body 306, to the handle 302 and/or connection shaft 305, while the throat 392 assists in providing a space between those elements. The throat 392 may in some examples be designed to allow for changes in a user/player's handling of the racket during various types of swings or hits, as well as allowing for changes to the sweet spot, vibrations and/or harmonics of the sport racket.

The sport racket body 306 may have various changes to its shape to improve performance. In some examples the sport racket body 306 may be included as part of the head and/or frame. It may be noted that some may consider the head to be where the strings are weaved between the frame portions, where the sport racket body 306 is part of the frame which may also include the racket split 307, connection shaft 305, and/or handle 302. For example, the racket split 307 of the sport racket body 306 may have different curves, arcs, or lines that allow for the perimeter of the sport racket body 306 to be maximized or minimized for the purposes of the sport racket body 306 design. Similarly, because of the positioning and/or shape of the shoulders 307 there can be a change in the sweet spot of the paddle or racket as vibrations and/or harmonics travel through the paddle or racket. This allows for different paddles or rackets to be created for specific playing styles, and/or purposes. The sport racket body 306, in at least one example, are symmetrical, while in other examples, there may be an offset in relationship to the center line 309 that runs through the handle 302. Then there is the top 310 that completes the perimeter of the sport racket body 306. The perimeter of the sport racket body 306 encompasses the sport racket surface (shown in FIGS. 9A and 9B) (in some examples the racket surface is the strings or a solid surface depending on the sport). The surface is utilized to strike a ball or shuttlecock, or other item). In at least one embodiment, the sport racket body 306 may include multiple layers of materials, in some examples there may be a single layer while in others there may be hundreds of layers. At least one of these layer can include a hybrid boron fiber carbon fiber prepreg. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 306 may include an edge guard 314 that can protect the edges of the layers, body, and/or frame that connect to the sport racket surface (shown in FIGS. 9A and 9B). In at least one embodiment, the edge guard 314 is a solid material that is permanently attached to the sport racket body 306 or sport racket surface (shown in FIGS. 9A and 9B). In some examples, the edge guard 314 may be removable to allow for the sport racket body 306 or sport racket surface (shown in FIGS. 9A and 9B) to be inspected. In some examples, the sport racket body 306 may allow for there to be layers such as a first layer 320A, a second or middle layer 320B, and/or a third or final layer 320C that are manufactured of similar or different materials. For example, in one example the first and third layers 320A/320C are made with a Hy-Bor™ prepreg, while the second or middle layer 320B is manufactured of a material that allows for desired or maximum efficiency for the racket surface 312 to be engaged. In other examples, the order of the material may be different, or have different effectiveness to achieve athlete goals. While not a common feature, if an edge guard 314 is placed in a manner that the strings or string bed of a racket, or portions of the paddle body pass through the edge guard 314, the edge guard 314 may be made of different materials to trigger different responses from the racket or paddle.

It should be noted for a third time that when a frame or sport racket body 306 is utilized and manufactured using a fiber-reinforced composite material, there can be additional benefits based on the string bed or sport racket surface 312. Due to the rigidity and/or flexibility of the fiber-reinforced composite material there can be various improvements to performance of the sports racket. For example, if more energy can be provided to the ball (rebound) or other target, then a player can benefit. By using the fiber-reinforced composite material to reduce or increase frame material damping, and/or various frictions (strings, grommets, etc.) at appropriate points, the boundary condition can be set to maximize performance. The fiber-reinforced composite material can be modified to improve the stiffness and deformation of the sport racket body 306 and/or sport racket surface 312. Similarly, by using various layers of fiber-reinforced composite material to address grommet, drill, and body load points either by reinforcement or a material reduction in those locations, other design benefits may also be achieved. With changes to the bending stiffness and/or torsional stiffness a sport racket can be made more uniform and also return or settle quicker after a target is hit, allowing a user to return to control more quickly and in a more uniform manner.

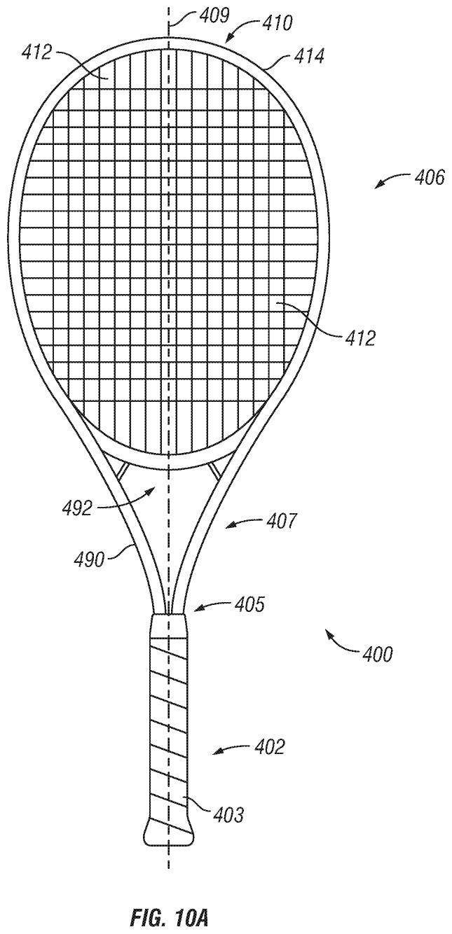

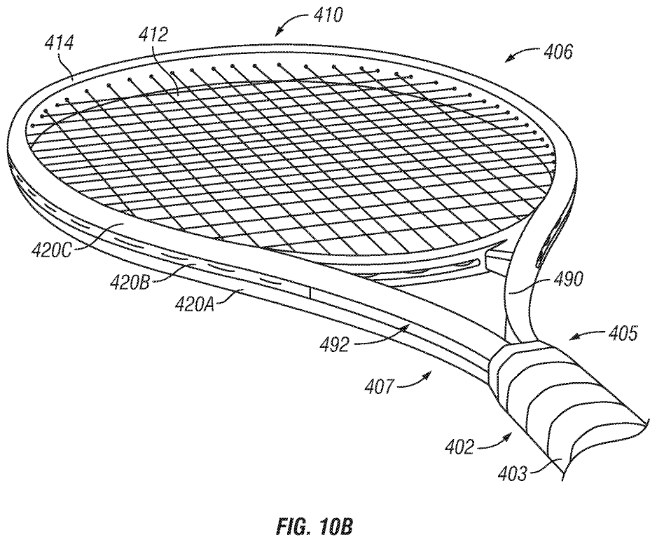

FIG. 10A is a front view of a tennis racket referred to as sports racket 400 (may be referred to as a paddle). The sport racket 400 can have a handle 402, a connection shaft 405, the sport racket body 406, and racket split 407. Any portion of the sport racket handle, shaft, head, body, split, or frame may be made with a Hy-Bor™ prepreg (may be referred to as a fiber-reinforced composite material). The Hy-Bor™ prepreg may be present in the sports racket in part or in whole; at any layer or in multiple layers of the composite bulk. All of which can be made with a hybrid boron fiber carbon fiber prepreg. The handle 402 can be shaped to allow for a user (not illustrated) to have maximum grip of the sport racket 400. In some examples, there may be a grip wrap or tape 403 that can wrap or engage with the handle 402. This grip wrap or tape 403 can allow a user to select their preference on the type of grip, the shape of the grip, and the stickiness of the grip material. Additionally, there may be different types of grips that can be added to the handle in addition to the grip wrap or tape.

The connection shaft 405 can allow for the coupling of the handle 402 to the sport racket body 406. In some examples, the handle 402 and sport racket body 406 may be made from one material, such as but not limited to a hybrid boron fiber carbon fiber composite material, and the connection shaft 405 and/or racket split 407 is for decorative purposes. While in other examples, the connection shaft 405 can be utilized to ensure a solid connection of the handle 402 with the sport racket body 406. While in other examples, the connection shaft 405 can be used to ensure that the grip wrap or tape 403 is not hindering the sport racket body 406 or its structure. In some examples, a fastener or adhesive may be used to secure the connection 404 to the handle 402 and/or racket body 406. Similarly, there may be a need for a connection 404 to be a ringlike structure that can be replaced with the face, face surface, or face surface laminate, or for cosmetic purposes as well. Regardless, the connection 404 allows for the securing of the handle 402 with the racket body 406, if they are not made of one piece.

As used herein, racket split may also be referred to as a shoulder or shoulders and is intended to be used in its broadest sense and refers to the structural transition region between the handle or shaft and the head or body of the sports racket (may be referenced to as racket body). Depending on the specific type of racket, ‘shoulders’ may also be referred to, or further comprise, a yoke, a throat, a neck, or a racket split (or a combination thereof any one or more these pieces). These terms are used interchangeably to describe the structural area that may include different curves, arcs, or lines designed to maximize or minimize the perimeter of the sport racket body, define the sweet spot, and manage vibrations or harmonics traveling through the racket. In a tennis racket embodiment, the shoulders may specifically include a yoke and throat that form part of a closed loop frame supporting a string bed. A yoke 490 may allow for a coupling to occur from the racket body 406, to the handle 402 and/or connection shaft 405, while the throat 492 assists in providing a space between those elements. The throat 492 may in some examples be designed to allow for changes in a user/player's handling of the racket during various types of swings or hits, as well as allowing for changes to the sweet spot, vibrations and/or harmonics of the sport racket.

The sport racket body 406 may have various changes to its shape to improve performance. In some examples the sport racket body 406 may be included as part of the head and/or frame. It may be noted that some may consider the head to be where the strings are weaved between the frame portions, where the sport racket body 406 is part of the frame which may also include the racket split 407, connection shaft 405, and/or handle 402. For example, the racket split 407 of the sport racket body 406 may have different curves, arcs, or lines that allow for the perimeter of the sport racket body 406 to be maximized or minimized for the purposes of the sport racket body 406 design. Similarly, because of the positioning and/or shape of the shoulders 407 there can be a change in the sweet spot of the paddle or racket as vibrations and/or harmonics travel through the paddle or racket. This allows for different paddles or rackets to be created for specific playing styles, and/or purposes. The sport racket body 406, in at least one example, are symmetrical, while in other examples, there may be an offset in relationship to the center line 409 that runs through the handle 402. Then there is the top 410 that completes the perimeter of the sport racket body 406. The perimeter of the sport racket body 406 encompasses the sport racket surface 412 (in some examples the racket surface is the strings or a solid surface depending on the sport). The surface is utilized to strike a ball or shuttlecock, or other item). In at least one embodiment, the sport racket body 406 may include multiple layers of materials, in some examples there may be a single layer while in others there may be hundreds of layers. At least one of these layer can include a hybrid boron fiber carbon fiber prepreg. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 406 may include an edge guard 414 that can protect the edges of the layers, body, and/or frame that connect to the sport racket surface 412. In at least one embodiment, the edge guard 414 is a solid material that is permanently attached to the sport racket body 406 or sport racket surface 412. In some examples, the edge guard 414 may be removable to allow for the sport racket body 406 or sport racket surface 412 to be inspected. While not a common feature, if an edge guard 414 is placed in a manner that the strings or string bed of a racket, or portions of the paddle body pass through the edge guard 414, the edge guard 414 may be made of different materials to trigger different responses from the racket or paddle.

It should be noted that when a frame or sport racket body 406 is utilized and manufactured using a fiber-reinforced composite material, there can be additional benefits based on the string bed or sport racket surface 412. Due to the rigidity and/or flexibility of the fiber-reinforced composite material there can be various improvements to performance of the sports racket. For example, if more energy can be provided to the ball (rebound) or other target, then a player can benefit. By using the fiber-reinforced composite material to reduce or increase frame material damping, and/or various frictions (strings, grommets, etc.) at appropriate points, the boundary condition can be set to maximize performance. The fiber-reinforced composite material can be modified to improve the stiffness and deformation of the sport racket body 406 and/or sport racket surface 412. Similarly, by using various layers of fiber-reinforced composite material to address grommet, drill, and body load points either by reinforcement or a material reduction in those locations, other design benefits may also be achieved. With changes to the bending stiffness and/or torsional stiffness a sport racket can be made more uniform and also return or settle quicker after a target is hit, allowing a user to return to control more quickly and in a more uniform manner.

FIG. 10B is a lower perspective side view of a tennis racket referred to as sports racket 400 (may be referred to as a paddle). The sport racket 400 can have a handle 402, a connection shaft 405, the sport racket body 406, and racket split 407. Any portion of the sport racket handle, shaft, head, body, split, or frame may be made with a Hy-Bor™ prepreg. The Hy-Bor™ prepreg may be present in the sports racket in part or in whole; at any layer or in multiple layers of the composite bulk. All of which can be made with a hybrid boron fiber carbon fiber prepreg. The handle 402 can be shaped to allow for a user (not illustrated) to have maximum grip of the sport racket 400. In some examples, there may be a grip wrap or tape 403 that can wrap or engage with the handle 402. This grip wrap or tape 403 can allow a user to select their preference on the type of grip, the shape of the grip, and the stickiness of the grip material. Additionally, there may be different types of grips that can be added to the handle in addition to the grip wrap or tape.

The connection shaft 405 can allow for the coupling of the handle 402 to the sport racket body 406. In some examples, the handle 402 and sport racket body 406 may be made from one material, such as but not limited to a hybrid boron fiber carbon fiber composite material, and the connection shaft 405 and/or racket split 407 is for decorative purposes. While in other examples, the connection shaft 405 can be utilized to ensure a solid connection of the handle 402 with the sport racket body 406. While in other examples, the connection shaft 405 can be used to ensure that the grip wrap or tape 403 is not hindering the sport racket body 406 or its structure. In some examples, a fastener or adhesive may be used to secure the connection 404 to the handle 402 and/or racket body 406. Similarly, there may be a need for a connection 404 to be a ringlike structure that can be replaced with the face, face surface, or face surface laminate, or for cosmetic purposes as well. Regardless, the connection 404 allows for the securing of the handle 402 with the racket body 406, if they are not made of one piece.

As used herein, racket split may also be referred to as a shoulder or shoulders and is intended to be used in its broadest sense and refers to the structural transition region between the handle or shaft and the head or body of the sports racket (may be referenced to as racket body). Depending on the specific type of racket, ‘shoulders’ may also be referred to, or further comprise, a yoke, a throat, a neck, or a racket split (or a combination thereof any one or more these pieces). These terms are used interchangeably to describe the structural area that may include different curves, arcs, or lines designed to maximize or minimize the perimeter of the sport racket body, define the sweet spot, and manage vibrations or harmonics traveling through the racket. In a tennis racket embodiment, the shoulders may specifically include a yoke and throat that form part of a closed loop frame supporting a string bed. A yoke 490 may allow for a coupling to occur from the racket body 406, to the handle 402 and/or connection shaft 405, while the throat 492 assists in providing a space between those elements. The throat 492 may in some examples be designed to allow for changes in a user/player's handling of the racket during various types of swings or hits, as well as allowing for changes to the sweet spot, vibrations and/or harmonics of the sport racket.

The sport racket body 406 may have various changes to its shape to improve performance. In some examples the sport racket body 406 may be included as part of the head and/or frame. It may be noted that some may consider the head to be where the strings are weaved between the frame portions, where the sport racket body 406 is part of the frame which may also include the racket split 407, connection shaft 405, and/or handle 402. For example, the racket split 407 of the sport racket body 406 may have different curves, arcs, or lines that allow for the perimeter of the sport racket body 406 to be maximized or minimized for the purposes of the sport racket body 406 design. Similarly, because of the positioning and/or shape of the shoulders 407 there can be a change in the sweet spot of the paddle or racket as vibrations and/or harmonics travel through the paddle or racket. This allows for different paddles or rackets to be created for specific playing styles, and/or purposes. The sport racket body 406, in at least one example, are symmetrical, while in other examples, there may be an offset in relationship to the center line 409 that runs through the handle 402. Then there is the top 410 that completes the perimeter of the sport racket body 406. The perimeter of the sport racket body 406 encompasses the sport racket surface 412 (in some examples the racket surface is the strings or a solid surface depending on the sport). The surface is utilized to strike a ball or shuttlecock, or other item). In at least one embodiment, the sport racket body 406 may include multiple layers of materials, in some examples there may be a single layer while in others there may be hundreds of layers. At least one of these layer can include a hybrid boron fiber carbon fiber prepreg. For example, in some versions, the face, face surface, or face surface layer (on some rackets this may be replacing strings, string bed, or other mechanisms) may be interchangeable or replaceable in a manner that allows for flexibility and adaptability for each type of player, as well as creating longevity for the paddle or racket.

A perimeter of the sport racket body 406 may include an edge guard 414 that can protect the edges of the layers, body, and/or frame that connect to the sport racket surface 412. In at least one embodiment, the edge guard 414 is a solid material that is permanently attached to the sport racket body 406 or sport racket surface 412. In some examples, the edge guard 414 may be removable to allow for the sport racket body 406 or sport racket surface 412 to be inspected. In some examples, the sport racket body 406 may allow for there to be layers such as a first layer 420A, a second or middle layer 420B, and/or a third or final layer 420C that are manufactured of similar or different materials. For example, in one example the first and third layers 420A/420C are made with a Hy-Bor™ prepreg, while the second or middle layer 420B is manufactured of a material that allows for desired or maximum efficiency for the racket surface 412 to be engaged. In other examples, the order of the material may be different, or have different effectiveness to achieve athlete goals. While not a common feature, if an edge guard 414 is placed in a manner that the strings or string bed of a racket, or portions of the paddle body pass through the edge guard 414, the edge guard 414 may be made of different materials to trigger different responses from the racket or paddle.

It should be noted that when a frame or sport racket body 406 is utilized and manufactured using a fiber-reinforced composite material, there can be additional benefits based on the string bed or sport racket surface 412. Due to the rigidity and/or flexibility of the fiber-reinforced composite material there can be various improvements to performance of the sports racket. For example, if more energy can be provided to the ball (rebound) or other target, then a player can benefit. By using the fiber-reinforced composite material to reduce or increase frame material damping, and/or various frictions (strings, grommets, etc.) at appropriate points, the boundary condition can be set to maximize performance. The fiber-reinforced composite material can be modified to improve the stiffness and deformation of the sport racket body 406 and/or sport racket surface 412. Similarly, by using various layers of fiber-reinforced composite material to address grommet, drill, and body load points either by reinforcement or a material reduction in those locations, other design benefits may also be achieved. With changes to the bending stiffness and/or torsional stiffness a sport racket can be made more uniform and also return or settle quicker after a target is hit, allowing a user to return to control more quickly and in a more uniform manner.

While the present disclosure has been discussed as having minimal changes in the playing characteristics, it would be understood that if beneficial changes to the playing characteristics of the game were found, they would be considered as part of the scope of this disclosure. In some examples, the coupling of the covering could include any means of removable coupling between two surfaces, such as glues, adhesives (particularly those that allow for later removal with minimal damage or residue to the surfaces), magnetics, or other coupling means. If a residue is left, it would be preferred if a simple wiping down would clean the surfaces of the sport racket. Additionally, it would be considered include in the spirit of this present disclosure if a sport racket was made without an edge guard.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure but should not be constrained by the headings set forth herein.

We claim:

1. A sports racket comprising:
a handle;
a shaft or connection point coupled to the handle;
a frame coupled to the shaft or connection point, the frame comprising at least one of a racket split, yoke, throat, shoulders, side edges, and a top edge; and
a surface surrounded by the frame;
wherein at least one component of the sports racket comprises a layer of hybrid boron fiber carbon fiber prepreg, the prepreg comprising boron fiber and carbon fiber reinforcing fibers in a surrounding resin matrix.

2. The sports racket of claim 1, wherein the boron fibers and carbon fibers are co-mingled at the fiber level within the prepreg tape.

3. The sports racket of claim 1, further comprising a removable covering coupled to the surface, wherein the removable covering comprises a layer of hybrid boron fiber carbon fiber prepreg.

4. The sports racket of claim 3, wherein the removable covering is coupled to the surface or an edge guard by hook-and-loop fasteners, adhesive, or a cartridge-style mounting that engages the edge guard.

5. The sports racket of claim 3, wherein the removable covering is configured to modify at least one performance characteristic selected from the group consisting of strike point, power, pop, spin, and audible frequency of the sports racket.

6. The sports racket of claim 1, wherein the frame or surface comprises a multi-layer laminate having a first outer layer, a second middle layer, and a third outer layer, wherein at least one of the first outer layer and the third outer layer comprises the hybrid boron fiber carbon fiber prepreg and the second middle layer comprises a different material.

7. The sports racket of claim 6, wherein the first and third layers comprise the hybrid boron fiber carbon fiber prepreg and the second middle layer is selected to optimize energy transfer or damping at the surface.

8. The sports racket of claim 1, wherein the hybrid boron fiber carbon fiber prepreg comprises boron fibers at a density of between 10 and 900 filaments per inch (fpi) of tape width.

9. The sports racket of claim 1, wherein the hybrid boron fiber carbon fiber prepreg is disposed in the neck area between the handle and the frame.

10. The sports racket of claim 1, wherein the hybrid boron fiber carbon fiber prepreg is disposed around the perimeter of the frame.

11. The sports racket of claim 1, wherein the hybrid boron fiber carbon fiber prepreg is disposed in the face sheet or surface.

12. The sports racket of claim 1, wherein the surrounding resin matrix is selected from the group consisting of epoxy, bismaleimide, and cyanate ester resins.

13. A method of manufacturing a sports racket, comprising the steps of:
selecting at least one component of a racket from the group consisting of a handle, a shaft or connection point coupled to the handle, a frame coupled to the shaft or connection point, the frame comprising at least one of a racket split, yoke, throat, shoulders, side edges, and a top edge, and a surface surrounded by the frame;
forming said at least one component of the racket from a hybrid boron fiber carbon fiber prepreg comprising boron fibers and carbon fibers in a resin matrix; and
laminating the prepreg in one or more layers in a selected region of the racket selected from the group consisting of the neck area, perimeter, face sheet, and surface.

14. The method of claim 13, wherein the sports racket is a stringed racket and the selected region includes the throat, yoke, or shaft.

15. A method of increasing torsional stiffness and control of a sports racket, the method comprising:
selecting at least one component of a sports racket from the group consisting of a neck area between a handle and a paddle or racket face and a perimeter of a paddle or racket frame;
forming the at least one selected component from a hybrid boron fiber-carbon fiber prepreg comprising boron fibers and carbon fibers in a resin matrix; and
laminating the hybrid boron fiber-carbon fiber prepreg in one or more layers in the at least one selected component such that, when the sports racket is used to strike a ball, torsional stiffness of the sports racket about a longitudinal axis is increased relative to a comparison sports racket lacking the hybrid boron fiber-carbon fiber prepreg in the at least one selected component, thereby increasing control and providing a more consistent hand feel during off-center impacts.

16. The method of claim 15, further comprising the step of co-mingling the boron fibers and carbon fibers at the fiber level within the prepreg tape.

17. The method of claim 16, wherein the boron filaments have a density of 10 to 900 filaments per inch (fpi) of tape width.

18. The method of claim 17, wherein the boron filaments have a density of 52 to 208 filaments per inch (fpi) of tape width.

19. The method of claim 18, wherein the hybrid boron fiber carbon fiber prepreg is disposed in at least one of the handle, shaft, connection point, frame, or surface region.

20. A method of modifying a noise signature produced during contact between a sports racket and a ball, the method comprising:
selecting at least one component of a sports racket from the group consisting of a handle, a shaft or connection point coupled to the handle, a frame coupled to the shaft or connection point, and a ball-striking surface;
providing a unitary hybrid preform material wherein boron filaments and carbon fibers are integrated and co-mingled at the individual filament level within a single prepreg tape;
forming the at least one selected component from the unitary hybrid preform material; and
laminating the unitary hybrid preform material in one or more layers in a selected region consisting of a neck area, a perimeter of the frame, or within a face sheet laminate,
wherein the integrated co-mingling of the boron filaments increases the damping coefficient of the selected region to attenuate vibrations generated via ball-to-sports racket impact;
wherein, when the sports racket is impacted with the ball, a noise signature of an impact noise produced by contact between the sports racket and the ball is modified relative to a comparison sports racket lacking the hybrid boron fiber-carbon fiber prepreg in the at least one selected region when the comparison sports racket is impacted with a ball under similar conditions, the noise signature comprising at least one of a frequency spectrum, dominant frequency band, or temporal decay profile of the impact noise.
